(19) United States
(12) Patent Application Publication
(10) Pub. No.: US 2008/0258640 A1
(43) Pub. Date: Oct. 23, 2008

(54) Discharge lamp lighting apparatus

(75) Inventor: Shigemi Masuda, Kitasaku-gun (JP)

Correspondence Address: OLIFF & BERRIDGE, PLC, P.O. BOX 320850, ALEXANDRIA, VA, 22320-4850, US

(73) Assignee: MINEBEA CO., LTD., KITASAKU-GUN (JP)

(21) Appl. No.: 12/081,007

(22) Filed: Apr. 9, 2008

(30) Foreign Application Priority Data
Apr. 23, 2007 (JP) 2007-112906

(51) Int. Cl. H05B 37/02

(52) U.S. Cl. 315/224

(57) ABSTRACT

A discharge lamp lighting apparatus includes: an inverter circuit; a lamp current detecting portion; and a burst mode control circuit which includes a noise reduction circuit including: an error amplification circuit to receive a feedback signal from the lamp current detecting portion; and a frequency response reduction circuit connected to the error amplification circuit, wherein the frequency response reduction circuit receives a dimming pulse signal for the burst mode dimming control, and the response characteristic of the noise reduction circuit is lowered while the dimming pulse signal is outputted, whereby the lamp current waveforms is suppressed from making a sharp change at the time of burst dimming control.

### BACKGROUND OF THE INVENTION

1. Field of the Invention

The present invention relates to a discharge lamp lighting apparatus, and particularly to a discharge lamp lighting apparatus to perform brightness adjustment by burst mode dimming control.

2. Description of the Related Art

What is called “burst mode dimming control” is one method employed for a discharge lamp lighting apparatus to adjust brightness of a discharge lamp. The burst mode dimming control is performed such that a voltage for driving a discharge lamp is outputted intermittently so as to provide turn-on time and turn-off time of the discharge lamp, and a ratio of the on/off-time in the intermittent action of high frequency current flowing in the discharge lamp, that is a ratio of the turn-on/off time period of the discharge lamp, is varied thereby controlling a time averaged brightness.

In the burst mode dimming control, the driving frequency for the intermittent action (burst frequency) is an audio frequency of around several hundred Hz, and therefore burst noises are produced by magnetostriction caused in a magnetic core of a transformer or coil incorporated in the discharge lamp lighting apparatus as is generally known.

There are mainly two types of noise reduction measures taken in the burst mode dimming control. One is passive means to attenuate or block noises generated and the other is active means to suppress generation of noises itself. The passive means includes a method to shield the transformer and the coil with a sound insulating or absorbing material, and a method to disable a sound transmitting medium/effect by vacuum tight sealing. The active means includes a method to suppress or reduce noise generation itself by improving an electronic circuit, for example, such that the fluctuation of amplitude of an input voltage applied to an inverter is reduced at the time of burst mode dimming control (refer, for example, to Japanese Patent Application Laid-Open No. H6-68980, claim 1), or that the waveform of an input voltage is inclined thereby increasing the rise/fall time (refer, for example, to Japanese Patent Application Laid-Open No. 2000-58289, claim 3). That is to say, it has been verified both auditorily and through noise level measurement that noises are reduced by moderating the change of a lamp current at the time of burst mode dimming control, based on which the active measures can be successfully implemented.

A discharge lamp lighting apparatus disclosed in the aforementioned Japanese Patent Application Laid-Open No. H6-68980 is adapted to reduce the amplitude fluctuation of a voltage applied to a transformer or a coil, and includes: a high frequency power source to supply a high frequency power to a discharge lamp; a dimmer means to adjust the high frequency power so as to light the discharge lamp in a control manner; a DC voltage superimposing means to superimpose a DC voltage on the high frequency power source at the time of dimming control of low light flux; and a second power source to intermittently supply a DC high voltage to the discharge lamp at the time of low temperature, wherein when the dimming control is performed by the dimmer means at a low temperature, a DC voltage is superimposed on the discharge lamp by the DC voltage superimposing means so that the load line and the lamp characteristic curve overlap with each other at one point and at the same time a DC high voltage is intermittently applied to the discharge lamp by the second power source.

A discharge lamp lighting apparatus disclosed in the aforementioned Japanese Patent Application Laid-Open No. 2000-58289 is adapted to cause an input voltage applied to an inverter to have an inclined waveform at the time of burst mode dimming control, and includes: an inverter circuit to convert a DC voltage into an AC voltage, which has its output voltage applied to a discharge lamp thereby lighting the discharge lamp; a lamp current detecting means to detect a lamp current flowing in the discharge lamp and convert into a voltage; a current control means to control a conducting direction and a conducting current for a primary winding of a transformer of the inverter circuit according to a control voltage; a burst signal generating means to generate and output a burst signal voltage which has a voltage level equal to or lower than a predetermined threshold voltage level and which has the voltage level varying with a predetermined inclination at a frequency lower than the frequency of the AC voltage outputted from the inverter circuit; a feedback voltage generating means to add up the burst signal voltage applied and the output voltage of the lamp current detecting means by logical addition of a diode thereby generating and outputting a feedback voltage in accordance with a composite voltage of the burst signal voltage and the output voltage of the lamp current detecting means; a control voltage generating means to supply to the current control means a control voltage corresponding to the composite voltage; and a DC level varying means connected to the control voltage generating means and adapted to vary a DC level of the control voltage.

The discharge lamp lighting apparatus disclosed in the Japanese Patent Application Laid-Open No. H6-68980 supplies to the discharge lamp a voltage superimposed with a DC voltage, and consequently the life of the discharge lamp is shortened. Also, the discharge lamp lighting apparatus disclosed in the Japanese Patent Application Laid-Open No. 2000-58289 requires a triangular wave generating circuit to convert a square waveform voltage as a dimming pulse signal into a triangular wave, which results in an increase in a number of component parts thus causing deterioration of product reliability as well as cost increase.

### SUMMARY OF THE INVENTION

The present invention has been made in light of the problems described above, and it is an object of the present invention to provide a discharge lamp lighting apparatus which is constructed by a simple and inexpensive circuitry, and which maintains a required control characteristic at the time of steady driving of a discharge lamp and at the same time reduces noises at the time of burst mode dimming control.

According to an aspect of the present invention, there is provided a discharge lamp lighting apparatus to drive a light assembly including at least one discharge lamp, which includes: an inverter circuit including a transformer defining a primary side and a secondary side, and a transformer driving circuit to drive the primary side of the transformer thereby driving the light assembly connected to the secondary side of the transformer; a lamp current detecting portion to detect a lamp current flowing in the light assembly; and a control portion having a function of performing burst mode dimming control and adapted to control the transformer driving circuit, wherein the control portion includes: an error amplification circuit to which a feedback signal from the lamp current detecting portion is inputted; and a frequency response reduction circuit connected to the error amplification circuit thereby forming a noise reduction circuit.

In the aspect of the present invention, the frequency response reduction circuit may receive a dimming pulse signal for the burst mode dimming control, and the response characteristic of the noise reduction circuit may be lowered while the dimming pulse signal is outputted.

In the aspect of the present invention, the error amplification circuit may include an error amplifier having a first input terminal to which the feedback signal from the lamp current detecting portion is inputted via an input resistor, and a second input terminal to which a reference signal is inputted, and the frequency response reduction circuit may include at least one series connection of a passive element and a semiconductor switch element and be connected in parallel either between the first input terminal and an output terminal of the error amplifier or between both terminals of the input resistor.

In the aspect of the present invention, the passive element may be either a capacitor or a resistor.

In the aspect of the present invention, the semiconductor switch element may be either a transistor or an FET.

And, in the aspect of the present invention, the control portion may utilize a dimming pulse signal with a square waveform for the burst mode dimming control.

The discharge lamp lighting apparatus described above according to the present invention is constructed by a simple and inexpensive circuitry, is adapted to maintain a required control characteristic at the time of steady driving a discharge lamp and at the same time to reduce noises at the time of burst mode dimming control.

### BRIEF DESCRIPTION OF THE DRAWINGS

FIG. 1 is a block diagram of a discharge lamp lighting apparatus according to an embodiment of the present invention;

FIG. 2 is a circuitry of the discharge lamp lighting apparatus of FIG. 1;

FIG. 3 is a circuitry of a typical error amplification circuit generally adopted;

FIG. 4 is a chart of a frequency characteristic of the error amplification circuit of FIG. 3;

FIG. 5 is a circuitry of an exemplary noise reduction circuit according to the present invention;

FIG. 6 is a chart of a frequency characteristic of the noise reduction circuit of FIG. 5;

FIG. 7A is a chart of a voltage waveform of a dimming pulse signal Vs, FIG. 7B is a chart of a lamp current waveform with its envelope line produced against the dimming pulse signal Vs at the time of burst mode dimming control in case of a conventional burst mode control circuit, and FIG. 7C is a chart of a lamp current waveform with its envelope line produced against the dimming pulse signal Vs at the time of burst mode dimming control in case of a burst mode control circuit having the noise reduction circuit according to the present invention (refer, for example, to FIG. 5);

FIG. 8 is a circuitry of another exemplary noise reduction circuit according to the present invention using a resistor as a passive element of a frequency response reduction circuit; and

FIGS. 9A to 9I are circuitries of exemplary noise reduction circuits according to the present invention in case of an error amplification circuit having a phase compensation circuit.

### DETAILED DESCRIPTION OF THE INVENTION

An exemplary embodiment of the present invention will be described with reference to the accompanying drawings.

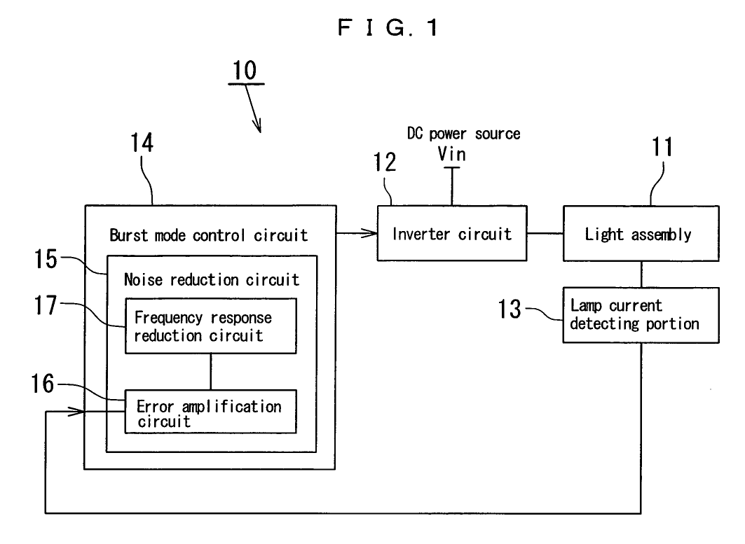

Referring to FIG. 1, a discharge lamp lighting apparatus 10 for driving a light assembly 11 includes an inverter circuit 12 connected to a DC power source Vin and adapted to output a lighting signal to the light assembly 11, a lamp current detecting portion 13 to detect a lamp current flowing in the light assembly 11, and a burst mode control circuit 14 as a control portion to control the function of the inverter circuit 12. The burst mode control circuit 14 includes a noise reduction circuit 15 which includes an error amplification circuit 16 to receive a feedback signal from the lamp current detecting portion 13 and a frequency response reduction circuit 17 connected to the error amplification circuit 16.

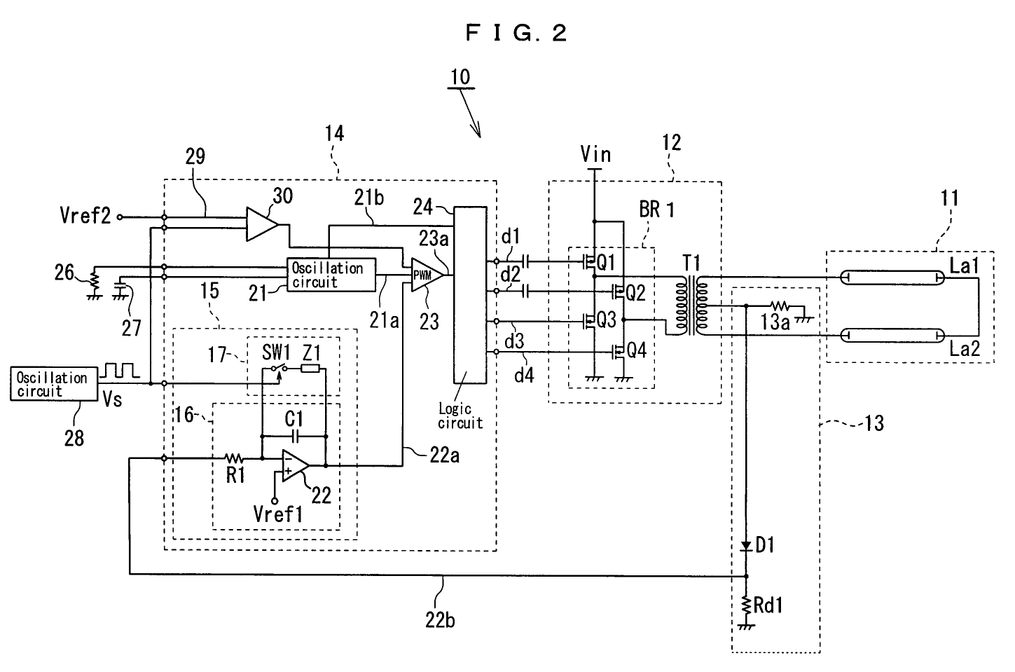

Description will be further made of the discharge lamp lighting apparatus 10 with reference to FIG. 2. The burst mode control circuit 14 is adapted to perform a burst mode dimming control when a mode detecting circuit (not shown) determines that a dimming pulse signal Vs, that is a periodical pulse signal, is inputted, while adapted to perform a steady driving when the mode detecting circuit determines that the dimming pulse signal Vs is not inputted.

The light assembly 11 to be driven by the discharge lamp lighting apparatus 10 includes two straight discharge lamps La1 and La2 connected in series to each other. The inverter circuit 12 includes a bridge circuit BR1 as a transformer driving circuit made up of four field effect transistors (FETs) Q1 to Q4, and a step-up transformer T1. The lamp current detecting portion 13 includes a resistance element 13a, a diode D1, and a resistance element Rd1.

The burst mode control circuit 14 principally includes, an oscillation circuit 21 (for example, CR oscillation circuit), a comparator 30, an error amplifier 22, a pulse width modulation (PWM) circuit 23, a logic circuit 24, and the aforementioned noise reduction circuit 15. These circuits may be constituted by appropriately using a semiconductor integrated circuit (IC), for example, BD9882F of Rohm Co., Ltd.

The error amplifier 22 has its first input terminal (inverting input terminal) connected in series to an input resistor R1, and a feedback voltage 22b from the lamp current detecting portion 13 is inputted to the error amplifier 22 via the input resistor R1. A reference signal Vref1 is inputted to a second input terminal (non-inverting input terminal) of the error amplifier 22. And an output signal 22a from the output terminal of the error amplifier 22 is inputted to the PWM circuit 23.

The noise reduction circuit 15 is made up of the error amplification circuit 16 and the frequency response reduction circuit 17. The frequency response reduction circuit 17 includes a series connection of an active element Z1 and a semiconductor switch element SW1 and is connected in parallel between the output terminal and the first input terminal of the error amplifier 22. In the present embodiment, the aforementioned dimming pulse signal Vs having a square waveform and outputted from an external oscillation circuit 28 is inputted to the semiconductor switch element SW1. The passive element Z1 may be a capacitor or resistor, and the semiconductor switch element SW1 may be a transistor (bipolar transistor) or an FET. In this connection, when the discharge lamp lighting apparatus 10 according to the present embodiment is used, for example, in a television receiver, and if a pulse available from a circuit to process a television signal can be converted and shared, then the external oscillation circuit 28 may be eliminated.

The oscillation circuit 21 generates a triangular wave 21a at a frequency according to the values of an external resistor 26 and an external capacitor 27 and outputs to the PWM circuit 23. A reference voltage Vref2 is externally applied to one terminal of the comparator 30, and the dimming pulse signal Vs having a frequency lower than that of the oscillation circuit 21 is inputted to the other input terminal of the comparator 30 from the external oscillation circuit 28. And, the PWM circuit 23 performs a burst mode dimming control based on an output signal from the comparator 30. Thus, the burst mode control circuit 14 performs a burst mode dimming control in such a manner that the dimming pulse signal Vs with a square waveform inputted from the external oscillation circuit 28 is inputted directly to the comparator 30 without shaping waveform, and that the output signal with a square wave from the comparator 30 is inputted to the PWM circuit 23. Accordingly, unlike the discharge lamp lighting apparatus disclosed in the Japanese Patent Application Laid-Open No. 2000-58289, the triangular wave generating circuit to convert a square wave voltage of a dimming pulse signal into a triangular wave is not required, which contributes to enhancing the reliability and reducing the cost. The timing of the output signal from the comparator 30 which functions as a buffer in the present embodiment can be adjusted where appropriate, such that the dimming pulse signal Vs is first processed through a low-pass filter or the like so that its waveform has gentle rising and falling edges, and is then inputted to the comparator 30.

Description will now be made of the operation of the discharge lamp lighting apparatus 10 at the time of a steady driving when the dimming pulse signal Vs is not outputted. In the burst mode control circuit 14, the oscillation circuit 21 generates a triangular wave 21a at a frequency according to the values of the external resistor 26 and the external capacitor 27 and outputs to the PWM circuit 23 as described above. The error amplifier 22 compares the feedback voltage 22b from the lamp current detecting portion 13 with the reference voltage Vref1 predetermined, and outputs to the PWM circuit 23 the output signal 22a which has a voltage according to the error value detected. The PWM circuit 23 compares the triangular wave signal 21a with the output signal 22a of the error amplifier 22, then generates a PWM pulse signal 23a having a pulse width corresponding to the level of the output signal 22a, and outputs to the logic circuit 24. Then, based on the PWM pulse signal 23a and a predetermined signal 21b synchronized with the triangular wave signal 21a from the oscillation circuit 21, the logic circuit 24 generates gate driving signals d1 to d4 which have a pulse width corresponding to the pulse width of the PWM pulse signal 23a and which turn on and off the pair of the FETs Q1 and Q4 and the pair of the FETs Q2 and Q3 alternately thereby driving the bridge circuit BR1. This causes a lamp current corresponding to the pulse width of the PWM pulse signal 23a to flow in the discharge lamps La1 and La2.

Thus, in the discharge lamp lighting apparatus 10, an AC voltage with a predetermined frequency is generated at the primary side of the step-up transformer T1 and boosted by the step-up transformer T1, and a driving voltage is applied to the discharge lamps L1a and La2 connected in series to each other and connected across both terminals of the secondary side of the step-up transformer T1 thereby lighting the discharge lamps La1 and La2 in a control manner.

During the lighting operation, the lamp current flowing in the discharge lamps La1 and La2 is detected by the resistance element 13a of the lamp current detecting portion 13 connected to the secondary side of the step-up transformer T1 and is rectified by the diode D1, and the maximum lamp current of the discharge lamps La1 and La2 is converted by the resistance element Rd1 into the feedback voltage 22b to be inputted to the error amplifier 22 of the error amplification circuit 16. Based on the feedback voltage 22b, the burst mode control circuit 14 controls the switching operation of the bridge circuit BR 1 by PWM modulation thereby adjusting the electric power applied to the step-up transformer T1 and controlling the lamp current of the discharge lamps La1 and La2.

The present invention is not limited in circuit configuration to the circuitry shown in FIG. 2, and a discharge lamp lighting apparatus may have a circuitry selected from variations not deviating from the scope and spirit of the present invention. For example, the bridge circuit BR1 is a full-bridge circuit in FIG. 2 but may alternatively be a half-bridge circuit, or the like. Also, the light assembly 11 to be driven by the discharge lamp lighting apparatus 10 is composed of a series connection of the discharge lamps La1 and La2 having a straight shape in FIG. 2 but may alternatively be composed of various types of discharge lamps in various connection modes. Further, the feedback voltage 22b is inputted to the inverting input terminal of the error amplifier 22 in FIG. 2 but may alternatively be inputted to the non-inverting input terminal thereof, in which case the input resistor R1 is connected in series to the first input terminal (a non-inverting input terminal in this case) of the error amplifier 22, wherein the feedback voltage 22b from the lamp current detecting portion 13 is inputted to the error amplifier 22 via the input resistor R1, and the reference voltage Vref1 is inputted to the second input terminal (an inverting input terminal in this case) of the error amplifier 22.

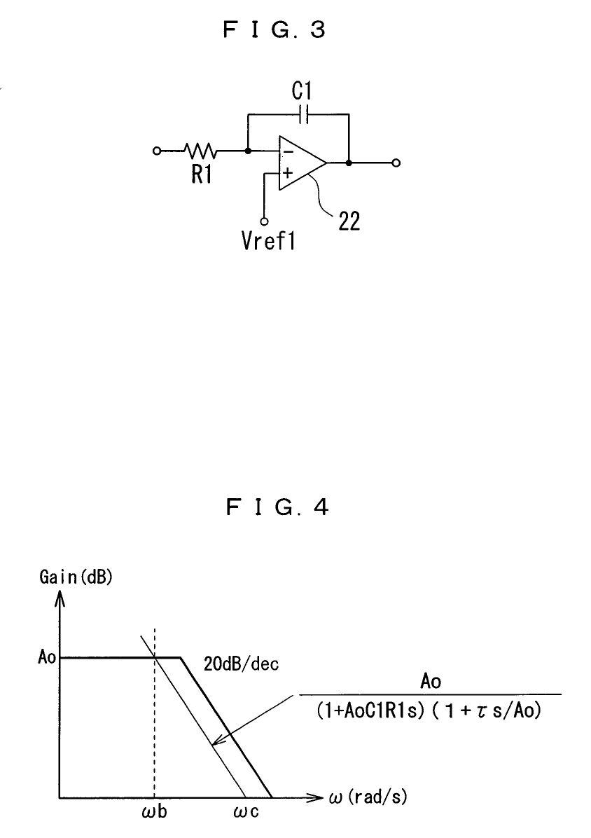

The noise reduction circuit 15 will be described with reference to FIGS. 3 to 6 together with FIG. 2. FIG. 3 shows a circuitry of an error amplification circuit typically adopted and used also in the discharge lamp lighting apparatus 10 as shown in FIG. 2 (the error amplification circuit 16). Referring to FIG. 3 and also FIG. 2, the input resistor R1 is connected to the negative input terminal of the error amplifier 22 as described above, and a capacitor C1 is connected in parallel between the negative input terminal and the output terminal of the error amplifier 22 thus forming an integration circuit. Referring to FIG. 4 showing the frequency characteristic of the error amplification circuit 16 with its horizontal axis representing an angular frequency ω and its vertical axis representing a gain, the error amplification circuit 16 has a roll-off characteristic of 20 dB/dec, and its frequency characteristic is given by an approximate formula: −Ao/(1+AoC1R1s)×(1+τs/Ao), where Ao is a gain with no feedback of the error amplifier 22 applied, τ is a time constant, and s is a Laplace operator, wherein a low-pass filter is formed where a gain crossover angular frequency ωc is approximated by a formula: ωc=1/(R1×C1), and a break point angular frequency ωb is approximated by a formula: ωb=1/(Ao×R1×C1).

Accordingly, if the capacitor C1 has a larger capacitance, the gain crossover angular frequency ωc is shifted toward the lower frequency side, which results in that the frequency response characteristic of the control system is lowered and therefore the output current is suppressed from making a sharp change. Consequently, the waveform of the output voltage (current) is caused to have a gentle slope at rising thus achieving reduction in noise attributable to magnetostriction.

However, when the gain crossover angular frequency ωc and the break point angular frequency ωb are set at a small value, the control bandwidth is narrowed, which causes a delay in response to the change of an input voltage or an output impedance. That is to say, setting the capacitance of the capacitor C1 of the error amplification circuit 16 with a view to reduce noises attributable to magnetostriction inevitably causes deterioration in the control characteristic at the time of the steady operation of a discharge lamp, and therefore it is difficult in the error amplification circuit 16 to reduce the noises at the time of burst mode dimming control and at the same time to maintain the control characteristic at the time of steady operation.

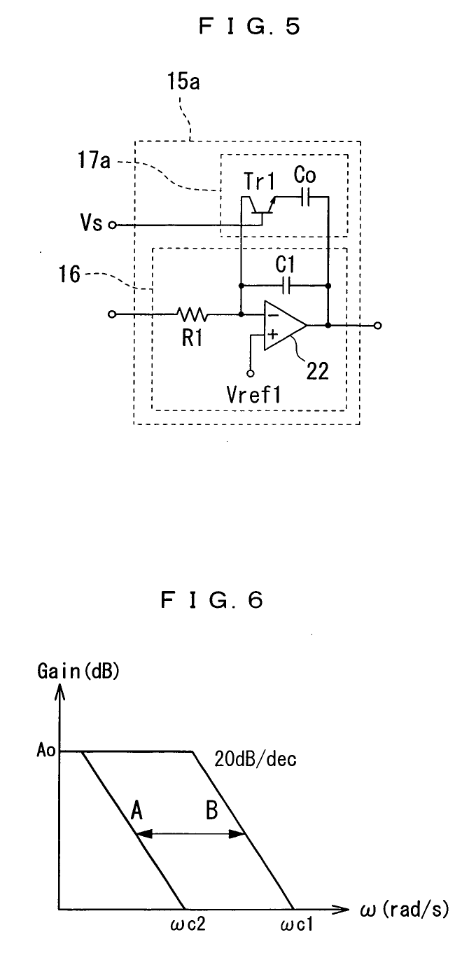

An example of the noise reduction circuit 15, together with the operation of the discharge lamp lighting apparatus 10 at the time of burst mode dimming control, will be described with reference to FIGS. 5, 6, 7A, 7B and 7C.

Referring to FIG. 5, an exemplary noise reduction circuit 15a includes the error amplification circuit 16 of FIG. 3 and further an exemplary frequency response reduction circuit 17a which is a series connection of a capacitor Co (corresponding to the passive element Z1 of FIG. 2) and a transistor Tr1 (corresponding to the semiconductor switch element SW1 of FIG. 2) and which is connected in parallel with the capacitor C1 of the error amplification circuit 16.

The noise reduction circuit 15a described above has a circuitry similar to that of, for example, a mirror integration circuit for use with an AC to DC conversion circuit. At the time of the stead operation of a discharge lamp, the output of the oscillation circuit 28 stays always at low level with the transistor Tr1 turned off, at which time the output of the error amplifier 22 depends only on the input resistor R1 and the capacitor C1, and not on the capacitor Co.

On the other hand, at the time of burst mode dimming control, the noise reduction circuit 15a receives externally the dimming pulse signal (square wave signal) Vs for modulation, with which the transistor Tr1 is turned on and off in synchronization. When the transistor Tr1 is turned on, the capacitor Co is connected in parallel with the capacitor C1 therefore causing the feedback capacitance of the noise reduction circuit 15a to increase, and when the transistor Tr1 is turned off, the capacitor Co is disconnected from the capacitor C1 thus transiting to a state which is similar to the steady operation. Consequently, the noise reduction circuit 15a has its frequency characteristic making a state transition between A and B in synchronization with the dimming pulse signal Vs (refer to FIG. 6). Since the gain crossover angular frequency ωc2 obtained when the transistor Tr1 is turned on is shifted toward the lower frequency side compared with the gain crossover angular frequency ω1 obtained at the time of stead operation (when the transistor Tr1 is turned off) as shown in FIG. 6, the response characteristic of the error amplification circuit 16 is lowered.

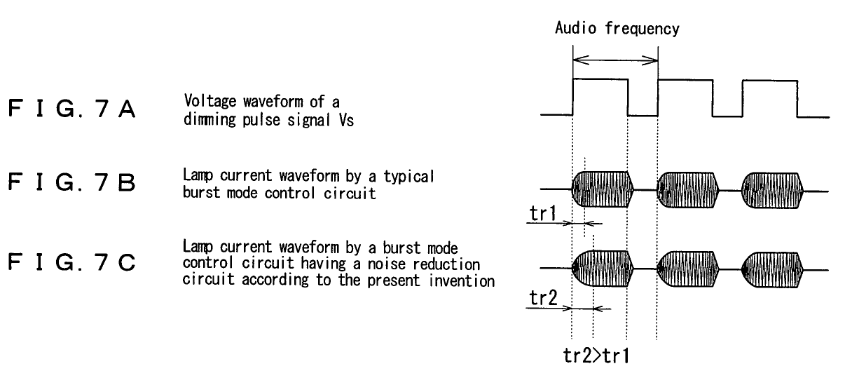

FIG. 7A shows a voltage waveform of the dimming pulse signal Vs at the time of burst dimming control, FIG. 7B shows a lamp current waveform generated in case of a typical burst mode control circuit which includes the error amplification circuit 16 (see FIG. 3) but excludes the frequency response reduction circuit 17 shown in FIG. 2, and FIG. 7C shows a lamp current waveform generated in case of the burst mode control circuit 14 provided with the noise reduction circuit 15a according to the present invention which includes the frequency response reduction circuit 17a as well as the error amplification circuit 16. At the time of burst mode dimming control, the PWM circuit 23 operates by the output from the comparator 30 in synchronization with the dimming pulse signal Vs of FIG. 7A such that the logic circuit 24 intermittently stops the gate driving signals d1 to d4 for the FETs Q1 to Q4. Referring to FIGS. 7B and 7C in conjunction with FIG. 7A, the discharge lamps La1 and La2 are turned on when the dimming pulse signal Vs is at a predetermined high level and are turned off when the dimming pulse signal Vs is at a predetermined low level.

In the discharge lamp lighting apparatus 10 according to the present embodiment, when the dimming pulse signal Vs is at the high level predetermined, the transistor Tr1 is turned on thereby connecting the capacitor Co in parallel with the capacitor C1, and accordingly the feedback capacitance of the noise reduction circuit 15a is caused to increase, which results in increasing a rise time. Consequently, the lamp current waveform of FIG. 7C has a rise time tr2 longer than a rise time tr1 of the lamp current waveform of FIG. 7B, from which it turns out that the response characteristic of the noise reduction circuit 15a is lowered and the lamp current waveform has a gentle rising slope. As a result, since a voltage applied to the step-up transformer T1 has a longer rise time, an effect from the magnetostriction caused in the transformer T1, specifically at a magnetic core thereof, is reduced, and accordingly the noises generated at the time of burst mode dimming control can be duly reduced.

While the present invention has been illustrated and explained with respect to the specific embodiment and exemplars thereof, it is to be understood that the present invention is by no means limited thereto but encompasses all changes and modifications that will become possible within the scope of the present invention.

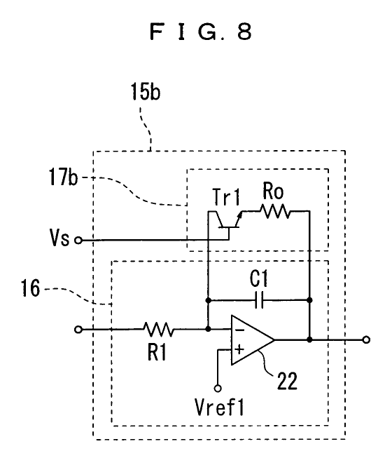

For example, in the frequency response reduction circuit 17a of the noise reduction circuit 15a of FIG. 5, the capacitor Co is used as the passive element Z1 (FIG. 2), but may be substituted by a resistor Ro as shown in FIG. 8. In this case, it must be designed that the gain crossover angular frequency obtained when the semiconductor switch element SW1 is turned on is lower than the gain crossover angular frequency obtained when the semiconductor switch element SW1 is turned off.

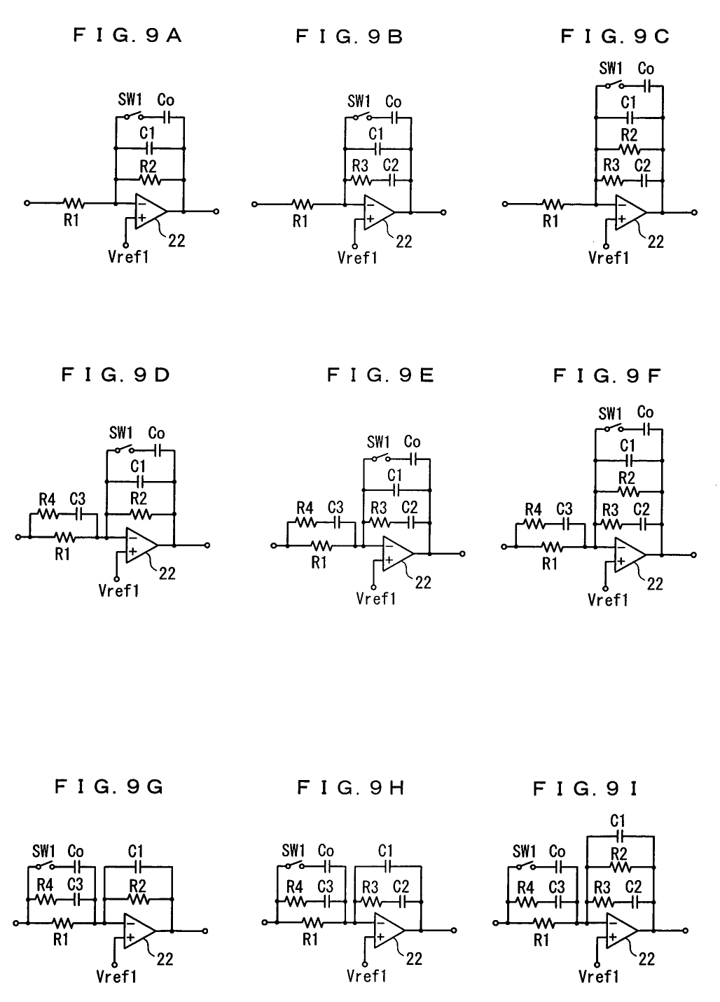

Also, the present invention is not limited in error amplification circuit configuration to the error amplification circuit 16 of FIG. 3, but may incorporate any error amplification circuit configuration including any one of various phase compensation circuits in combination with a frequency response reduction circuit so as to make up a noise reduction circuit. FIGS. 9A to 9I show exemplary noise reduction circuits, in each of which a frequency response reduction circuit formed by a series connection of a semiconductor switch element SW1 and a capacitor Co is connected in parallel either between the output terminal of the error amplifier 22 and the input (inverting input) terminal thereof (refer to FIGS. 9A to 9F) or between the both terminals of the input resistor R1 (refer to FIGS. 9G to 9I).

Further, the dimming pulse signal Vs is an external signal in the embodiment but may alternatively be produced internally by a dimming pulse signal generating circuit provided inside the burst mode control circuit 14.

And, the control method utilizing the comparator 30 in the embodiment only represents an example of performing burst mode dimming control, and the noise reduction circuit according to the present invention can be applied to any appropriate control method of performing burst mode dimming control.

Accordingly, in the discharge lamp lighting apparatus described above, the noise reduction circuit is structured such that the frequency response reduction circuit is added to the error amplification circuit, whereby the response of the noise reduction circuit is delayed in synchronization with the dimming pulse signal only at the time of burst mode dimming control, which results in reducing noises caused by the magnetostriction in the magnetic cores of the transformer or the coil. Also, since the response is delayed only when the dimming pulse signal is turned on, the control characteristic is not deteriorated at the time of steady driving of the discharge lamp. That is to say, the discharge lamp lighting apparatus according to the present invention, while constructed with a simple and inexpensive circuitry, can maintain a desired control characteristic and at the same time reduce noises at the time of burst mode dimming control.

In the explanation described above, the response characteristic of the noise reduction circuit is controlled such that the response is delayed only when the dimming pulse signal is applied to the semiconductor switch element of the frequency response reduction circuit thereby turning on the semiconductor switch element, but the present invention is not limited to such an arrangement and may alternatively be arranged such that the semiconductor switch element is always turned on at the time of burst mode dimming control and is always turned off at the time of steady driving, whereby the response of the output signal of the noise reduction circuit is slower at the time of burst mode dimming control than at the time of steady driving. Specifically, for example, a circuit to generate a predetermined DC signal using as a trigger for the rising edge of the first pulse of the dimming pulse signal is added, and the DC signal is applied to the semiconductor switch element so as to cause the semiconductor switch element to be always turned on at the time of burst mode dimming control, whereby the fall time of the lamp current waveform as well as the rise time can be increased, which results in further reducing noises effectively.

What is claimed is:

1. A discharge lamp lighting apparatus to drive a light assembly including at least one discharge lamp, the discharge lamp lighting apparatus comprising:
an inverter circuit including a transformer defining a primary side and a secondary side, and a transformer driving circuit to drive the primary side of the transformer thereby driving the light assembly connected to the secondary side of the transformer;
a lamp current detecting portion to detect a lamp current flowing in the light assembly; and
a control portion having a function of performing burst mode dimming control and adapted to control the transformer driving circuit, wherein the control portion comprises an error amplification circuit to which a feedback signal from the lamp current detecting portion is inputted, and a frequency response reduction circuit connected to the error amplification circuit thereby forming a noise reduction circuit.

2. A discharge lamp lighting apparatus according to claim 1, wherein the frequency response reduction circuit receives a dimming pulse signal for the burst mode dimming control, and a response characteristic of the noise reduction circuit is lowered while the dimming pulse signal is outputted.

3. A discharge lamp lighting apparatus according to claim 1, wherein the error amplification circuit comprises an error amplifier having a first input terminal to which the feedback signal from the lamp current detecting portion is inputted via an input resistor, and a second input terminal to which a reference signal is inputted, and wherein the frequency response reduction circuit comprises at least one series connection of a passive element and a semiconductor switch element and is connected in parallel either between the first input terminal and an output terminal of the error amplifier or between both terminals of the input resistor.

4. A discharge lamp lighting apparatus according to claim 3, wherein the passive element is one of a capacitor and a resistor.

5. A discharge lamp lighting apparatus according to claim 3, wherein the semiconductor switch element is one of a transistor and an FET.

6. A discharge lamp lighting apparatus according to claim 1, wherein the control portion utilizes a dimming pulse signal with a square waveform for the burst mode dimming control.
